(19) United States
(12) Patent Application Publication
(10) Pub. No.: US 2014/0009938 A1
(43) Pub. Date: Jan. 9, 2014

(54) LIGHT MODULE

(71) Applicant: Automotive Lighting Reutlingen GmbH, Reutlingen (DE)

(72) Inventor: Wolfgang Hossfeld, Gomaringen (DE)

(21) Appl. No.: 13/935,168

(22) Filed: Jul. 3, 2013

(30) Foreign Application Priority Data
Jul. 4, 2012 (DE) 10 2012 211 613.3

(51) Int. Cl. F21V 5/08

(52) U.S. Cl. CPC F21V 5/08
USPC 362/244

(57) ABSTRACT

A light module having a first and a second primary optics device wherein the individual LEDs of a first and a second semiconductor light source can be reproduced as real intermediate images on an intermediate image surface, wherein an intermediate image assigned to the first semiconductor light source is overlapping with at least one intermediate image assigned to a second semiconductor light source, and that a secondary optics device is arranged in such a way that the intermediate images can be projected as assigned light beam segments of the light beam distribution.

### CROSS-REFERENCE TO RELATED APPLICATION

This application is based upon and claims priority to German Patent Application 10 2012 211 613.3 filed on Jul. 4, 2012.

### BACKGROUND OF INVENTION

1. Field of Invention

The invention relates to a light module for a lighting device for a motor vehicle. Such light modules are used as high beam headlights in motor vehicle headlamps.

2. Description of the Related Art

Normally, it is desired to achieve a light beam distribution with high homogeneity. Basically, strip-shaped areas of the light beam distribution should be avoided because they show different light because they may be considered to be annoying. On the other hand, as far as possible, the high beam headlights in motor vehicle headlamps should not have a glare.

To this end, the EP 2 280 215 A2 describes a motor vehicle headlamp which comprises a plurality of LED light source modules for light transmission in basically parallel beam direction.

Each LED light source module comprises one or multiple LEDs which can emit source light segments. Furthermore, each LED light source module comprises a prime lens element for concentrating light emitted by the LEDs. In addition, each LED light source module comprises a secondary optics by means of which the light segments generated by the prime lens elements can be reproduced in an area located in front of the motor vehicle. At the same time, the at least two LED light source modules in a motor vehicle headlamp are arranged to each other in such a way that the source light segments from the individual LED light source modules are projected offset to one another in horizontal direction. As a result, multiple light modules are combined in one headlamp. In the motor vehicle headlamp described in the EP 2 280 215 A2, the LED light sources of the individual light source modules can be controlled independently from one another. To avoid dazzling an oncoming vehicle, individual light sources can be hidden.

An alternative approach is described in the JP 2010132170. This publication shows motor vehicle headlamps which generate light beam distributions with multiple adjacent strip-shaped light beam segments. At the same time, the light sources of a headlamp can be controlled in such a way that individual strip-shaped light beam segments can be hidden in order to specifically avoid dazzling oncoming traffic. To generate the desired uniform light beam distribution, the JP 2010132170 proposes to arrange on a motor vehicle two headlamps of this type spaced apart from one another so that the individual light beam segments overlay in relation to the light beam distribution.

The known solutions have the problem that the provision of uniform light beam distribution and the facilitation of antiglare high beam requires multiple headlamps, at least multiple light modules that have to be combined with and adjusted to one another. This requires extensive coordination and adjustment of the individual components, which can result in high production costs. Moreover, it poses a problem to integrate into such complex arrangements further light function, such as lateral illumination, daytime running lights, indicator lights or a low beam light or a dimmed light distribution.

Therefore, the invention is based on the objective of providing in a simple and cost-effective manner a high beam with uniform light beam distribution and glare protection for oncoming traffic. A further objective of the invention involves a simple and cost-effective integration of additional light function, for example, a dimmed light distribution.

### SUMMARY OF INVENTION

The present invention overcomes the disadvantages of the related art in a light module having a first and second primary optics where each LED (light-emitting diode) can be represented in one respectively assigned real intermediate image on an intermediate image surface, and that one intermediate image that has been respectively assigned to the first semi-conductor light source overlaps with at least one intermediate image assigned to the second semi-conductor light source on the intermediate image surface. Furthermore, the secondary optics device has been designed as mutual secondary optics device for the first and the second primary optics device and arranged in such a way that the intermediate images of LEDs emitting a source light segment that are assigned to the first and the second semi-conductor light source can be projected as respectively assigned light beam segments of the light beam distribution.

Therefore, in the light module of the present invention, two or even multiple semi-conductor light sources are combined with a respectively assigned primary optics device. As a result, it is possible to generate a great beam of illumination. At the same time, it is advantageous that only one secondary optics device is required which is used for collectively projecting intermediate images assigned to the first, the second and any potential further semi-conductor light sources. Consequently, it is possible to save installation space and material costs with the invention-based module.

The secondary optics device does not have to be made in a way that it can generate an optical image. Instead, it is sufficient when the intermediate image can be projected in a main beam direction for generating light beam distribution, for example, in the case of a motor vehicle headlamp the area in front of the vehicle, or as collimated light beam for generating a high beam. However, the secondary optics device can be designed also as a projection lens or can comprise one.

In the light module of the present invention, the overlapping light beam segments of the light beam distribution can each be attributed to assigned intermediate images of LEDs (which emit an assigned source light segment). These intermediate images are generated by means of the primary optics device. If an adjustment of the alignment of semi-conductor light sources and/or primary optics devices is required for generating a desired, in particular uniform light beam distribution, this can be easily performed by the light module of the present invention. In contrast to the well-known solutions for generating the above-mentioned light beam distributions, it is not required to adjust different light modules or even different headlamps to one another. Therefore, when producing the light module, it is possible to provide a module-specific constructive solution for an adjustment of the semi-conductor light sources and/or the primary optics devices. The light module is independent of the design of the headlamp housing into which, for example, multiple light modules can be installed. As a result, the light module of the present invention can be used for a plurality of different headlamps and for a plurality of different types of housing. This makes the design work for such headlamps easier. Therefore, the light module of the present invention allows for more flexible structural solutions.

Since the secondary optics device projects multiple overlapping intermediate images as light beam distribution, the light module of the present invention makes it possible to generate uniform light beam distribution. In the present context, “uniform” does not necessary mean that the illuminated area has everywhere the same level of brightness. Instead, the light beam distribution can have areas of different brightness if transitions between these areas have such continuity that disturbing light effects are prevented. Apart from specifically hiding individual light beam segments in order to provide antiglare high beam, sharp transitions or offset strip-shaped areas of different brightness should be avoided. The light beam distribution (viewed from an observation level) should also not be “spotted”.

The primary optics devices are designed as optical imaging devices which can generate intermediate images of the source light segments on the intermediate image surface. Depending on the design of the primary optics device, the intermediate image surface does not have to be designed as a flat surface. However, simple principles result when the primary optics device is designed in such a way that it defines an intermediate image level in terms of geometric optics.

In the present context, a light segment (source light segment, light beam segment) involves a respective portion of a light distribution (source light distribution, intermediate light distribution, light beam distribution) attributed to a specific LED.

The light module of the present invention provides an antiglare, dynamic high beam in a simple and cost-effective manner. For this purpose, the first and the second semiconductor light sources are designed in such a way that individual LEDs of the first and the second semiconductor light source can be controlled for emitting light independently of one another. In particular, it can be sufficient when the mentioned semiconductor light sources, or the mentioned LEDs, are designed in such a way that they can be independently switched on and off.

As a result, it is possible to selectively hide individually emitted source light segments. On the intermediate image surface, an LED that emits a source light segment is assigned an intermediate light segment. By hiding a source light segment, the assigned intermediate light segment is also hidden on the intermediate image surface, i.e., the respective intermediate image is turning dark. As a result, the respectively assigned light beam segments are selectively hidden in the light beam distribution. For example, when viewing a high beam distribution of a motor vehicle headlamp with the light module of the present invention, by switching off individual or multiple LEDs it is possible to hide those light beam segments that would dazzle oncoming traffic. For this purpose, it is especially advantageous to use the light module of the present invention in which the light beam segments adjoin each other in horizontal direction, or in which they are arranged in overlapping manner. Therefore, the light module of the present invention provides a dynamic high beam or adaptive curve light.

According to one embodiment, the LEDs of the first and the second semiconductor light source are arranged in a linear array. In particular, the linear array comprises regularly spaced assembly positions for LEDs. In particular, the LEDs are arranged in a row, wherein the LEDs are designed in such a way that they are directly adjoining one another. Preferably, all LEDs of the first and the second semiconductor light source have an identical design.

However, to achieve a light beam distribution with a larger vertical expansion, it can also be advantageous when the LEDs of the first and the second semiconductor light source are always arranged in a planar array. Such a two-dimensional array provides regularly spaced matrix-like assembly positions for LEDs. An example to consider would be a multiline array. The individual LEDs, in turn, are especially designed as components that are directly adjoining one another.

In another embodiment, the first and the second semiconductor light source, respectively, include a plate-like support element on which the multiple LEDs of the respective semiconductor light source are arranged. In particular, the support element is a circuit board on which a plurality of identical LED chips are arranged as SMD components (“Surface Mounted Device”). In such components, the individual LED chips are usually arranged in the above-mentioned way as a linear or planar array. Such a structure allows for comparatively cost-effective semiconductor light sources with a large number of individual LEDs which, in turn, allows for great beam intensities. As a result, it is possible to produce extremely bright and cost-effective light modules. Each of the individual LEDs of the semiconductor light sources may include a bordered light-emitting surface, wherein the LEDs of each semiconductor light source are arranged in such a way that the edges of the LEDs extend parallel in pairs. In particular, the LEDs have basically square light-emitting surfaces. Thus it is possible to provide an array of the type mentioned above simply by arranging the individual LEDs in tile form next to one another.

In another embodiment of the light module of the present invention, the first and the second primary optics device, respectively, are designed in such a way that the intermediate images assigned to the first semiconductor light source are offset in horizontal direction in relation to the intermediate images assigned to the second semiconductor light source. When using the light module in a motor vehicle headlamp, the horizontal direction describes a direction that extends parallel to the road surface. The above-mentioned arrangement prevents vertically extending dark stripes from appearing in the light beam distribution, because the overlapping intermediate images on the intermediate image surface result in an almost uniformly illuminated area. This area is projected by the secondary optics device in a uniform light beam distribution.

Alternatively, it can be advantageous when the intermediate images assigned to the first semiconductor light source are offset also in a vertical direction that extends perpendicular to the horizontal direction in relation to the intermediate images assigned to the second semiconductor light source. For example, this makes it possible to provide a light beam distribution with an enlarged vertical expansion. When the intermediate images overlap in vertical direction they are projected by the secondary optics device in a light beam distribution that also has overlapping light beam segments. In particular, when the semiconductor light sources use a planar array of the type described above, it is possible to provide a light beam distribution with enlarged vertical expansion and uniform intensity distribution. As a result, it is possible to prevent disturbing horizontal stripes in the light beam distribution.

In another embodiment, the first and the second primary optics device can be designed in such a way that each LED is reproduced in an intermediate image which is so indistinct on the intermediate image surface that for an LED emitting a source light segment a continuous transition from light to dark is achieved along at least one direction on the intermediate image surface. In this respect, the primary optics devices are designed in such a way that blurred intermediate images are generated in at least one direction, i.e., the light-dark lines bordering an image of a source light segment on the intermediate image surface are blurred. Preferably, the above-mentioned indistinct or continuous transition is provided in the vertical direction, thus preventing disturbing horizontally extending sharp light transitions in the light beam distribution. For example, the above-mentioned indistinct transitions can be achieved in that the first and the second primary optics device comprise a cylindrical lens or a lens with different focal distances with regard to directions extending perpendicular to one another. However, it is also possible to use lenses with free-form surfaces which can bring about specific distortion or blurring of the intermediate images.

In another embodiment, the intermediate images assigned to a respective semiconductor light source border one another on the intermediate image surface, wherein the intermediate images assigned to the first semiconductor light source overlap more than half of the width of a respective intermediate image assigned to the second semiconductor light source. In this respect, the intermediate images of the first semiconductor light source and those of the second semiconductor light source overlap, respectively, half of the width of an LED image. In the above-mentioned embodiments, the intermediate images form an almost uniformly illuminated area on the intermediate image surface. The uniformly illuminated area is projected by the secondary optics device in an almost uniformly illuminated light beam distribution.

In particular, each of the semiconductor light sources comprises a plurality of identical LEDs, which are arranged in an array in such a way that adjoining LEDs are connected to one another. In particular, the LEDs are provided with square light-emitting surfaces. The first and the second primary optics devices are designed in such a way that the (especially also square) intermediate images reproduced on the intermediate image surface overlap, respectively, more than half of their width.

The primary optics device may include at least one convex lens. As a result, the desired representation of the source light segments in real intermediate images (intermediate light segments) can be achieved in a simple manner. It is also possible to use spherical lenses, which allow for a simple structure with high optical quality and which can be produced comparatively cost-effective.

In another embodiment, the first and/or the second primary optics device includes an optical element for correcting image defects. In particular, the optical element is provided in addition to an optical imaging element, for example, a convex lens. The optical imaging element has the purpose of producing the real intermediate image of the source light segments, whereas the previously mentioned optical element is able to correct image defects in combination with the imaging element. In this way, it is thus possible to avoid unwanted color edges of the light beam distribution by correcting the chromatic image defects already on the intermediate image surface. The optical element for correcting chromatic image defects could include an achromatic lens for correcting color image defects.

When the primary optics device includes multiple lenses, it is advantageous to provide the surfaces of the optical elements or lenses with an anti-reflection coating.

In another embodiment of the light module of the present invention, the secondary optics device is designed as a secondary convex lens which defines a focal point, whereas the secondary convex lens is arranged in such a way that the focal point is located on the intermediate image surface. As a result, the overlapping, real intermediate images (and the assigned intermediate light segments) can be represented, respectively, in light beams radiating almost parallel, which light beams define respectively assigned light beam segments. However, it is not required that the secondary optics device has optical imaging properties. The decisive factor is that the device has the ability of projecting intermediate images in a primary beam direction. It is also possible that the secondary optics device comprises a cylindrical lens (for example, with a focal line extending on the intermediate image surface) or a Fresnel lens or that it is designed as such. Furthermore, it is possible to use a free-form lens comprising the desired projection properties.

The light module can be supplemented in an advantageous manner by providing in addition at least one sidelight source by means of which light can be radiated on the intermediate image surface in such a way that a sidelight distribution can be projected with the secondary optics device especially in primary beam direction. At the same time, the sidelight distribution borders the light beam segments or surrounds the light beam segments in sections or completely. The light beam segments can provide the central illumination in high beam distribution, whereas the sidelight distribution provides a uniform light background and/or illuminates side portions. This makes it possible to illuminate a larger area outside of the central light beam segments. Therefore, the light module of the present invention may combine in a simple manner a sidelight with a headlamp using one and the same module.

At the same time, it is not required that the sidelight source also generates on the intermediate image surface light segments in the form of a real intermediate image. Therefore, the sidelight source principally does not require a primary optics device with optical imaging properties.

However, it can be of advantage to provide a side-emitting optical device that is assigned to a sidelight source. By means of the side-emitting optical device, light from the sidelight source can be concentrated or collimated on the intermediate image surface. As a result, the efficiency of lateral illumination is improved. For example, a TIP lens (“Total Internal Reflection Lens”) can be used as side-emitting optical device. The TIP lens may include at least one light ingress surface and at least one light-emitting surface, as well as a total internal reflection surface in such a way that light can be conducted almost without loss from the light ingress surface to the light-emitting surface. For example, it is possible to use as side-emitting optical device an optical head such as has been disclosed in the DE 486 303. It comprises a central lens element arranged on an optical axis and a catadioptric ring element surrounding the lens element which has an outer surface that can totally reflect the light of a light source. By means of such optical heads, it is possible to efficiently collect and concentrate light of a light source the light of which is radiated into a half-space in the direction of the optical axis.

However, it is also possible to use as side-emitting optical device a reflector for concentrating the light of the sidelight source. In particular, this can involve a parabolic reflector or a free-form reflector. It is also possible to use free-form lenses which concentrate the light of the sidelight source. Although the side-emitting optical device does not have to comprise any optical imaging properties, it is definitely possible to use optical imaging devices like the previously described primary optics devices.

The sidelight source can be designed in the same way as the previously described semiconductor light sources. Advantageously, the sidelight source may include multiple LEDs arranged in groups, for example, an LED array of the type described above. Therefore, with regard to further embodiments, reference is made to the descriptions involving the semiconductor light sources.

In still another embodiment, the sidelight source can be controlled independent from the first and/or the second semiconductor light source for light radiation. In particular, it can be designed in such a way that it can be independently switched on and off.

Furthermore, the light module of the present invention may be provided with an aperture having an aperture edge which can be arranged between the first and the second primary optics device and the secondary optics device in such a way that a light beam distribution can be achieved with partially horizontally extending light-dark edge. In particular, the aperture with the aperture edge can be arranged on or in the area of the intermediate image surface.

As a result, the light module of the present invention can generate a dimmed light distribution which corresponds to the legal requirements for motor vehicle lighting devices. In particular, it is possible to achieve an asymmetric light-dark edge with two offset horizontal portions which are connected by means of an ascending section.

In this respect, the secondary optics device projects the aperture edge on the road as light-dark edge of the resulting light beam distribution. Preferably, the aperture edge lies in the focal point or in the area of a focal point of a secondary optics device designed as projection lens. The aperture can extend in a horizontal plane wherein preferably the horizontal plane includes an optical axis of the projection lens or the secondary optics device. On the intermediate image surface the aperture acts in such a way that specific areas of the intermediate images are shaded. As a result, only sections of the intermediate images are projected by means of the secondary optics device.

In still another embodiment, the light module of the present invention includes an aperture actuator for moving the aperture in such a way that the aperture edge can be moved into the intermediate image surface and out of the intermediate image surface. At the same time, the aperture edge can be moved in vertical or horizontal direction out of the intermediate image surface and into the intermediate image surface. For example, the aperture actuator is designed in such a way that the aperture with the aperture edge can be tipped about a rotational axis. For this purpose, the aperture has, for example, a plate-like design and is arranged on the rotational axis of the aperture actuator.

In another embodiment, the light module of the present invention includes an adjusting device that acts to specifically change the relative position of the intermediate images of the first semiconductor light source in relation to the second semiconductor light source. For this purpose, for example, the adjusting device is designed in such a way that the first semiconductor light source can be shifted in a controlled manner in relation to the second semiconductor light source and/or in relation to the first primary optics device and/or in relation to the second primary optics device. It is also possible that the adjusting device is designed in such a way that the first primary optics device can be shifted in a controlled manner in relation to the second primary optics device.

An adjusting device makes it possible to control in a comfortable manner the light beam distribution of the light module by means of an adjustment within the light module. As a result, the light module that is designed in such a way can be combined in a component with other light modules without requiring a possibility for adjusting the light module in relation to one another. The light modules can be integrated as subassemblies in complex lighting devices. At the same time, it is not necessary to perform a difficult fine adjustment during the installation. The light module is a small and light component in a complex lighting device. Therefore, the mechanical constructions required for an adjustment are lighter and more cost-effective than corresponding adjusting devices for the entire lighting device. In addition, the adjusting device within the light module is independent of the design of a headlamp housing. As a result, the light modules can be installed in different types of headlamps with different types of housings, wherein it is not required to specifically adapt the adjusting device to the respective type of headlamp or the respective housing. This considerably reduces the construction effort for complex headlamps.

Other objects, features, and advantages of the invention are readily appreciated as it becomes more understood while the subsequent detailed description of at least one embodiment of the invention is read taken in conjunction with the accompanying drawing thereof.

### BRIEF DESCRIPTION OF THE DRAWINGS

FIG. 1 is a perspective view of one embodiment of the light module of the present invention;

FIG. 2 is a top view of the light module shown in FIG. 1;

FIG. 3 is a semiconductor light source for use in the light module of the present invention;

FIGS. 4-6 are schematic representations for exemplifying the light beam distribution of the light module according to FIGS. 1 and 2;

FIG. 7 is a semiconductor light source for use in the light module of the present invention;

FIG. 8 is a schematic representation for exemplifying the light beam distribution of the light module of the present invention;

FIG. 9 is a perspective view of another embodiment of the light module of the present invention;

FIGS. 10 and 11 are schematic representations for exemplifying a sidelight distribution;

FIG. 12 is a schematic representation for exemplifying the light beam distribution of a light module according to FIG. 9;

FIG. 13 is a schematic representation for providing a dynamic light distribution with a light module according to FIG. 9;

FIG. 14 is another embodiment of the light module of the present invention;

FIG. 15 is a schematic representation of the light beam distribution of a light module according to FIG. 14;

FIG. 16 is a side view of another embodiment of the light module of the present invention;

FIG. 17 is a side view of another embodiment of the light module of the present invention.

### DETAILED DESCRIPTION OF THE EMBODIMENTS OF THE INVENTION

In the following description identical or corresponding components are provided with the same reference numerals.

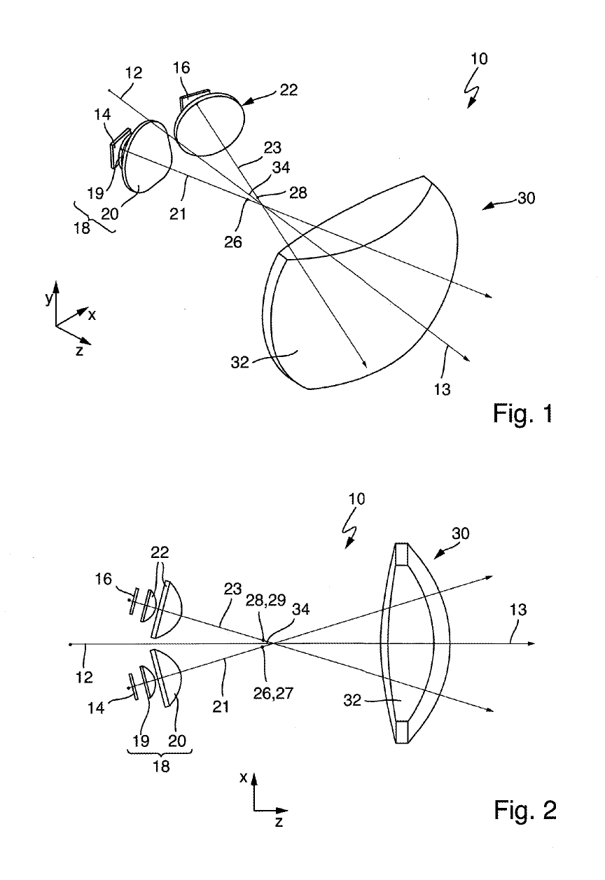

FIG. 1 shows a light module 10 of the present invention, which can be used, for example, in a motor vehicle headlamp for the purpose of providing a high beam. For the light module 10, an optical axis 12 has been defined which indicates a primary beam direction 13. For reasons of clarity, the light module 10 is shown without a housing, although any design of a housing can be provided.

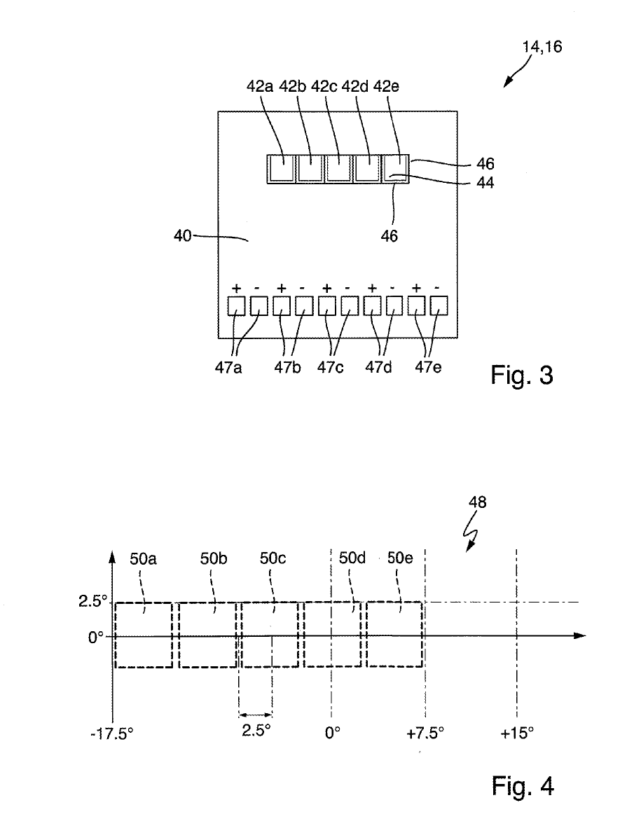

The light module 10 includes a first semiconductor light source 14 and a second semiconductor light source 16, which are described in more detail in the description of the embodiments shown in FIGS. 3 and 7. At any rate, each of the semiconductor light sources comprises a plurality of light-emitting diodes (LEDs) arranged in groups, wherein each LED of each semiconductor light source 14 or 16 is designed in such a way that it is possible to emit a source light segment assigned to the respective LED.

The first semiconductor light source 14 is assigned to a first primary optics device 18 in such a way that source light segments emitted by the first semiconductor light source 14 can be optically controlled. The first primary optics device 18 may include a first imaging lens 19 and a second imaging lens 20 which, for example, are designed as a convex lens. At the same time, the first primary optics device 18 defines a first optical primary axis 21.

The second semiconductor light source 16 is assigned to a second primary optics device 22 which has a structure corresponding to the first primary optics device 18 with two lenses as, for example, indicated in the top view in FIG. 2. The second primary optics device 22, in turn, defines a second optical primary axis 23.

The further design of the first primary optics device 18 and the second primary optics device 22 is subsequently described by means of the first primary optics device 18. The primary optics device 18 is designed in such a way that via the lens 19 and 20 along the first optical primary axis 21 an LED of the first semiconductor light source 14 is reproduced in a real intermediate image 26. Correspondingly the second primary optics device 22 reproduces an LED of the second semiconductor light source 16 along the optical axis 23 in a real intermediate image 28.

The real intermediate images 26 and 28 are on a mutual intermediate image surface. Where the intermediate image surface is designed as a test screen it is possible to see on the test screen intermediate light segments 27, 29 assigned to the real intermediate images 26 and 28. At the same time, the intermediate light segment 27 is assigned to the source light segment emitted by the above-mentioned LED of the first semiconductor light source 14. Correspondingly the intermediate light segment 29 is assigned to a source light segment of an LED of the second semiconductor light source 16.

Furthermore, the light module 10 includes a secondary optics device 30 by means of which the intermediate images 26 and 28 are projected in a light beam distribution along the primary beam direction 13.

In one embodiment, the secondary optics device 30 is designed as a projection lens, and more precisely as a secondary convex lens 32. The secondary convex lens 32 includes an optical axis which coincides with the primary beam direction 13. Furthermore, the secondary convex lens 32 defines a focal point 34. A light beam originating from the focal point 34 is reproduced by the secondary convex lens in a light beam extending parallel to the primary beam direction 13. The secondary convex lens 32 is designed and arranged in such a way that the focal point 34 is located almost on the intermediate image surface on which also the real intermediate images 26 and 28 are located. Therefore, the secondary convex lens 32 reproduces the intermediate images 26 and 28 in light beams extending almost parallel to the primary beam direction 13. The description concerning FIGS. 4 to 6 shows that light beam segments are assigned to said light beams.

FIG. 3 shows an exemplary embodiment for the first and second semiconductor light source 14 and 16. The semiconductor light source 14 or 16 comprises a support element 40 in the form of a circuit board on which a plurality of LEDs 42a to 42e are arranged in the form of a linear array. All LEDs 42a to 42e have an identical design. As, for example, demonstrated with LED 42e, each LED includes an almost square light-emitting surface 44 which is bordered by edges 46. At the same time, the square LEDs 42a to 42e are arranged in row-like arrays on the support element 40 in such a way that edges 46 of adjoining light-emitting surfaces 44 are directly parallel to one another. The edges 46 of different LEDs 42a to 42e extending vertically to the parallel edges are located on a mutual straight line. By means of the semiconductor light sources 14 and 16 designed in such a way, it is possible to radiate source light segments that are directly adjoining one another and that are assigned to the respective LEDs 42a to 42 e.

Via assigned contact pairs 47a to 47e, each of the LEDs 42a to 42e can be supplied with operating current. Therefore, each of the LEDs 42a to 42e can be electrically controlled independent of other LEDs, i.e., each LED 42a to 42e can be switched on and off independent of other LEDs. Therefore, it is possible to specifically hide individual source light segments. Thus, as subsequently described, antiglare high beam can be provided.

In the light module 10 represented in FIGS. 1 and 2, the entirety consisting of first semiconductor light source 14 and first primary optics device 18 in relation to the unit consisting of second semiconductor light source 16 and second primary optics device 22 is arranged in such a way that an intermediate image originating from the first semiconductor light source 14 is overlapping with at least one intermediate image originating from the second semiconductor light source 16. This is subsequently described in more detail with reference to FIGS. 4 to 6.

More specifically, FIGS. 4 to 6 represent the light beam distribution of the light module 10 in the respective operating conditions, as they can be seen on a test screen, which extends vertically to the primary beam direction 13 and which is spaced from the light module 10 along the primary beam direction 13. At the same time, it is assumed that the semiconductor light sources 14, 16 of the light module 10 are designed according to the embodiment shown in FIG. 3.

FIG. 4 shows the light beam distribution that involves the light module 10 when only the LEDs of the first semiconductor light source 14 are switched on. The light beam distribution 48 comprises multiple light beam segments 50a to 50e which correspond with the individual LEDs 42a to 42e. This is based on the fact that the secondary convex lens 32 projects as parallel beams the intermediate images generated in the area of its focal point 34 on the intermediate image surface. Since the first semiconductor light source 14 is designed in the way described in the context of FIG. 3, the real intermediate images of the light-emitting diodes 42a to 42e (I.e., their associated light-emitting surfaces) basically have a square design. The basically square intermediate images are then reproduced via the secondary optics device in the light beam segments 50a to 50e that basically also have a square design.

An image corresponding in quality to the image shown in FIG. 4 could be provided when a test screen was set up on the intermediate image surface. It would then be possible to see on the test screen basically square intermediate light segments assigned to the light beam segments 50a to 50e.

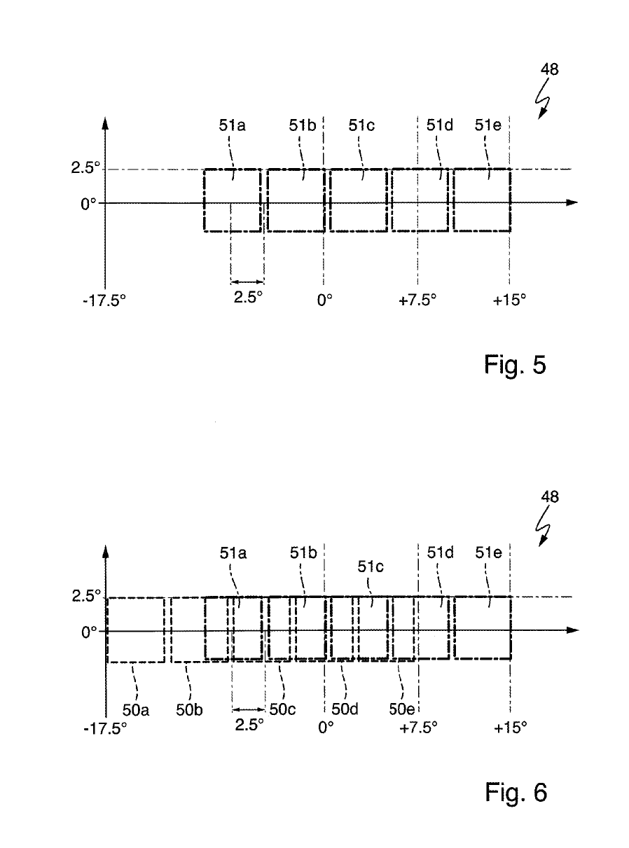

To determine the spatial position and orientation of the light beam segments, vertical and horizontal angular coordinates have been inserted in FIG. 4 (also in FIGS. 5 and 6). These correspond to coordinates on the coordinate plane defined by the Y axis (vertical) and X axis (horizontal). Compare the coordinate system indicated in FIGS. 1 and 2. At the same time, X and Y coordinates can be represented by angular specifications relating to the primary beam direction 13.

In a representation corresponding to FIG. 4, FIG. 5 shows the light beam distribution 48 of the light module 10 when, contrary to FIG. 4, only the second semiconductor light source 16 is operated. Again, as described above, the light beam distribution 48 comprises basically square light beam segments 51a to 51e, each of which is based on source light segments of the associated LEDs 42a to 42e.

FIGS. 1 and 2 show that the first optical primary axis 21 and the second optical primary axis 23 are positioned at a certain angle to each other and intersect in the proximity of the intermediate image surface or in the proximity of the focal point 34. At the same time, the imaging properties of the first primary optics device 18 and the second primary optics device 22, as well as their mutual alignment are selected in such a way that the light beam segments 51a to 51e based on the second semiconductor light source 16 are offset in horizontal direction (which corresponds to the X axis in the coordinate system according to FIGS. 1 and 2) in relation to the light beam segments 50a to 50e based on the first semiconductor light source 14. FIG. 5 shows that the light beam segments 51a to 51e on the test screen extend in an angular range of approximately between −7.5° and +15° horizontally, whereas the light beam segments 50a to 50e cover an angular range of approximately between −17.5° and +7.5° horizontally.

FIG. 6 shows the light beam distribution 48 of the light module 10, when the first semiconductor light source 14, as well as the second semiconductor light source 16, respectively, are operating with all LEDs. It is obvious that the light beam segments 51a to 51e are partially overlapping with the light beam segments 50a to 50e. At the same time, the light beam segments 51a to 51e based on the second semiconductor light source 16 are offset in horizontal direction in relation to the light beam segments 50a to 50e based on the first semiconductor light source 14 in such a way that, for example, light beam segment 51a overlaps in horizontal direction more than half of the respective width of the two light beam segments 50b and 50c adjoining one another. In this respect, the light beam segments of the first and second semiconductor light source 14 and 16 are offset by “half a pixel width”.

An image corresponding in quality to FIG. 6 would result on the intermediate image surface, wherein there an intermediate image of an LED of the second semiconductor light source 16 would overlap more than half of the width of an intermediate image of an LED of the first semiconductor light source 14.

When operating both semiconductor light sources 14 and 16, it is possible to generate a light beam distribution that is altogether largely uniform in its mid-range (i.e., in the range between −12.5° and 10°).

In addition, each of the light beam segments 50a to 50e can be specifically hidden in the light beam distribution. For this purpose, the LED 42a to 42e respectively assigned to the first semiconductor light source 14 is switched off. Accordingly, individual light beam segments 51a to 51e can be hidden by specifically switching off LEDs of the second semiconductor light source 16. As a result, it is possible to provide antiglare high beam distribution by specifically switching off LEDs of the first or second semiconductor light source whose respective source light segment is assigned to a light beam segment 50a to 50e or 51a to 51e that could ultimately result in dazzling an oncoming motor vehicle or a motor vehicle driving in front.

FIG. 7 shows another embodiment of the semiconductor light source 14 and 16 used, for example, with the light module 10 or other subsequently described light modules. Contrary to the semiconductor light source represented in FIG. 3, a large number of LEDs 54a to 54e and 55a to 55e are arranged in the manner of a regular, planar array on the support element 40. The array is formed in that a first, row-type arrangement of LEDs 54a to 54e is combined with a further row-type arrangement of LEDs 55a to 55e extending in parallel to the first arrangement in such a way that a respective LED within the row borders directly at least one adjoining LED and that one edge of a respective LED of a row borders directly an LED of the other row. The individual LEDs 54a to 54e and 55a to 55e of each row of the planar array can be electrically controlled independently of one another or can be switched on and off independently of one another via contact pairs 56a to 56e (for the first row 54a to 54e) and 57a to 57e (for the second row 55a to 55e).

For specific applications, it can be advantageous when light beam segments of the light beam distribution 48 become specifically blurred in vertical direction (Y direction) or are bordered in vertical direction by blurred edges which define in vertical direction a continuous transition from light to dark. As a result, it is possible, for example, to avoid in the light beam distribution 48 disturbing horizontal edges which would not be desirable when using the light module in a motor vehicle.

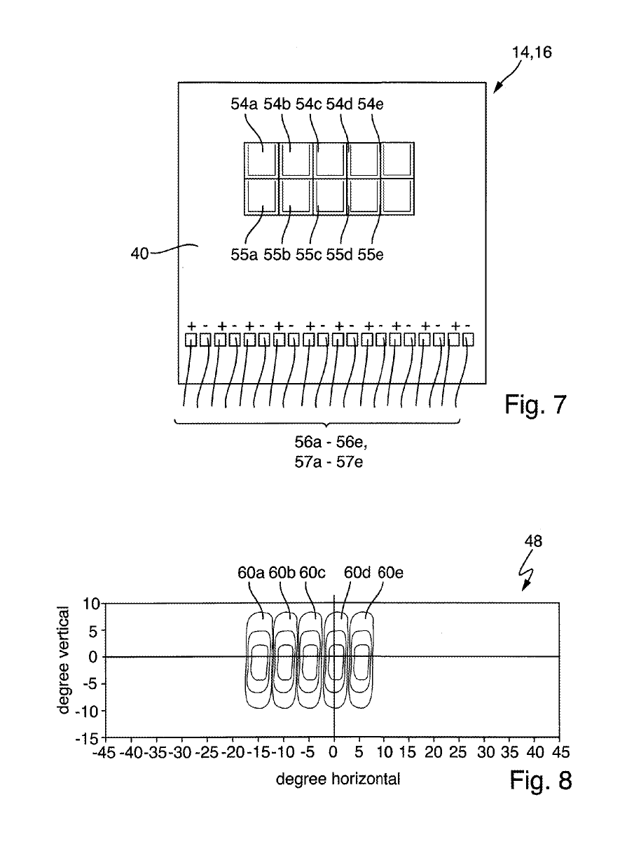

For reasons of clarification, FIG. 8 shows a light beam distribution 48 corresponding to the representations shown in FIGS. 4 to 6. Again, the light beam distribution 48 includes light beam segments 60a to 60e, wherein the light beam segments 60a to 60e have blurred edges in vertical direction (i.e., vertical angular component), which means that in vertical direction there is a continuous light-dark transition. Such a light beam distribution can be achieved by designing the first and second primary optics device 20 and 22 in such a way that each intermediate image on the intermediate image surface has a blurred edge along the vertical direction (Y direction in FIGS. 1 and 2), resulting in a continuous transition from light to dark along the vertical direction on the intermediate image surface. In this respect, the edges bordering the intermediate images are blurred.

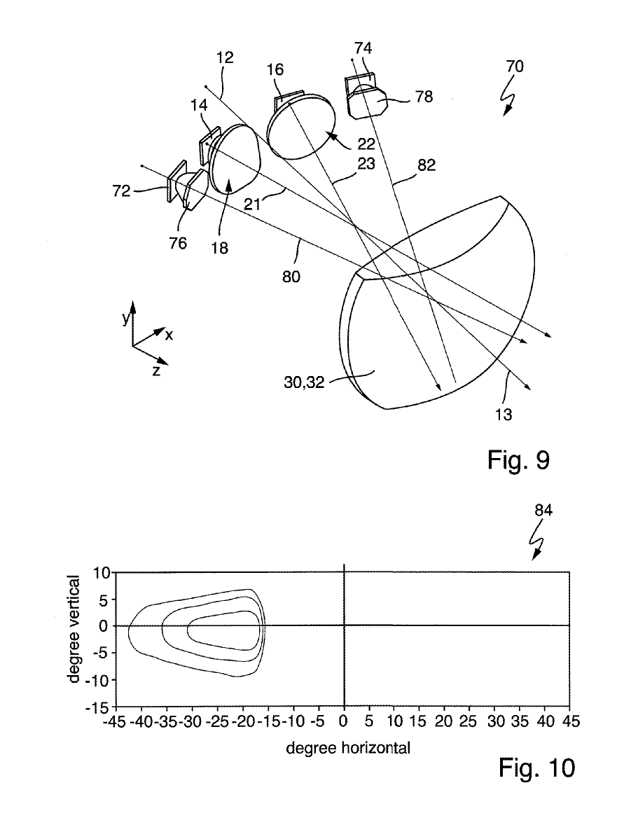

FIG. 9 shows a perspective view of a light module 70 by means of which it is possible to achieve in an advantageous manner an additional lateral illumination.

Basically, the light module 70 differs from the light module 10 in that a first sidelight source 72 and a second sidelight source 74 have been provided in addition to the semiconductor light sources 14 and 16. The sidelight sources 72 and 74 are also designed as semiconductor light sources of the type described in the context of FIG. 3 or FIG. 7. However, the sidelight sources can also be designed different from the first and second semiconductor light sources 14 and 16. In particular, it is possible that the sidelight sources 72 and 74 comprise only one LED, respectively, for light emission. This can be sufficient because lateral illumination usually requires only a lower light intensity than in the center where a maximum range should be achieved (for example, for a high beam function).

The sidelight sources 72 and 74 are designed to emit additional light in the area of the intermediate image surface, i.e., in the area of the point of intersection of the first optical primary axis 21 and the second primary axis 23 (as described in the context of FIGS. 1 and 2).

For this purpose, the first sidelight source 72 is assigned a first side-emitting optical device 76. The side-emitting optical device 76 defines a first lateral optical axis 80 which intersect the intermediate image surface. The first side-emitting optical device 76 acts in such a way that light emitted by the sidelight source 72 is collimated in relation to the first lateral optical axis 80 or, depending on the design, concentrated in the direction of said axis.

In the example shown, the first side-emitting optical device 76 is designed as an optical head of the first sidelight source 72 which includes a TIR lens with a light ingress surface facing the sidelight source 72. The TIR lens may be designed in such a way that almost all light from the sidelight source 72 can be concentrated to be radiated into the half-space in primary beam direction 13. In contrast to the primary optics devices 18 and 22, the side-emitting optical device 76 designed as an optical head does not allow the LED of the sidelight source 72 to be optically reproduced as a real intermediate image on the intermediate image surface.

By specifically designing optically effective surfaces of the side-emitting optical device 76 (for example, as free-form surfaces), it is possible to influence the light distribution applied to the intermediate image surface.

Correspondingly, the second sidelight source 74 is assigned a second side-emitting optical device 78 which defines a second lateral optical axis 82. With regard to the design of the second side-emitting optical device 78, reference is made to the above-mentioned description concerning the side-emitting optical device 76.

The side-emitting optical devices 76 and 78 are designed in such a way that the light emitted from the sidelight sources 72 and 74 on the intermediate image surface is projected by means of the side-emitting optical device 30 in a sidelight distribution 84 which completely surrounds the light beam distribution described in the context of FIGS. 4 to 6.

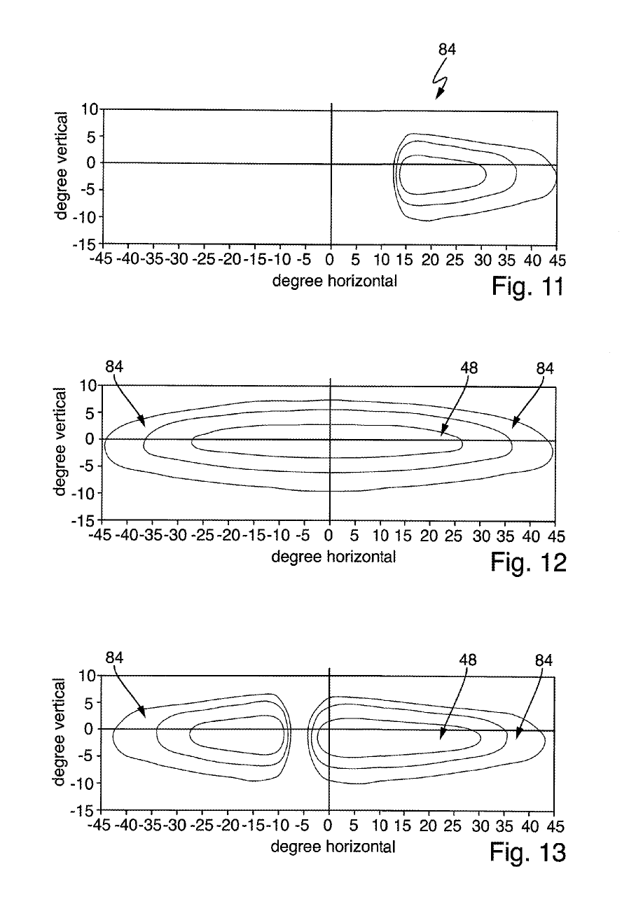

The above-mentioned sidelight distribution 84 is subsequently described in more detail by means of FIGS. 10 and 11 (in a representation on a test screen corresponding to FIGS. 4 to 6).

FIG. 10 shows the light distribution generated by the light module 70, when only the first sidelight source 72 is supplied with power for light emission. In this case, the remaining light sources (14, 16, 74) are switched off. Obviously, the light transferred from the first sidelight source 72 to the intermediate image surface is projected from the secondary optics device 30 to a section of the sidelight distribution 84, which corresponds to an outside area in horizontal direction (X axis or negative horizontal angle) with respect to the primary beam direction 13.

FIG. 11 shows a representation corresponding to the one shown in FIG. 10 in which only the second sidelight source 74 of the light module 70 is operating, and all other light sources (72, 14, 16) are switched off. In this case, a lateral area is illuminated that is located on the outside with respect to the primary beam direction 13.

The side portions illuminated by the respective sidelight sources 72 or 74 have an asymmetric shape. This is based on the fact that in the present case the side-emitting optical devices 76 or 78 are not designed as rotation-symmetric optical systems. On the other hand, the side-emitting optical devices 76 or 78 in the case of the light module 70 are designed as asymmetric optical heads.

FIG. 12 shows the light distribution emitted by the light module 70 for the case that both semiconductor light sources 72 and 74 are operating. At the same time, FIG. 6 shows that the central area of the test screen shown in FIG. 12 is illuminated by the light beam distribution (in the range of about 0° of horizontal and vertical deviation from the primary beam direction 13). In the process, the overlapping light beam segments 50a to 50e or 51a to 51e (see FIG. 6) form a uniformly illuminated area of high light intensity. The sidelight distribution 84, which results from an overlap of the partial sidelight distribution shown in FIGS. 10 and 11, surrounds the intensive central light beam distribution 48.

The light module 70 makes it possible that a specific area of intensive light beam distribution 48 can be hidden and still lateral illumination can be guaranteed with larger angles to the primary beam direction 13. This can be desirable for generating high beam distribution in which in special situations the central, intensive light beam distribution 48 should be hidden in angular ranges that could result in dazzling oncoming traffic, but lateral illumination should still be guaranteed.

FIG. 13 shows the light distribution emitted by the light module 70 when light is emitted by the sidelight sources 72 and 74 but individual LEDs of the first semiconductor light source 14 are hidden. At the same time, light is emitted basically by all LEDs of the semiconductor light source 16, but one of the LEDs is hidden (for example, 42e and possibly even 42d). However, it is also possible that light is emitted by all LEDs of the semiconductor light source 16. For example, when the semiconductor light source shown in FIG. 3 is used with the light module 70 in such a way that the light-emitting diodes 42a to 42e are facing the first primary optics device 18, the light distribution shown in FIG. 13 results from the fact that the LEDs 42a, 42d, 42e are operating, but the LEDs 42b and 42c are switched off. It can be seen that the light beam segments of the light beam distribution 48 assigned to the LEDs 42b and 42c are hidden (these correspond to the light beam segments 50b and 50c shown in the representation of FIG. 6). The remaining area of the light beam distribution 48 (corresponding to the light beam segments 50a, 50d, 50e and 51a to 51e) results in a light beam distribution 48 with a vertically extending dark portion. As described above, the sidelight distribution 84 in the outer horizontal angular ranges adjoins the central light beam distribution 48.

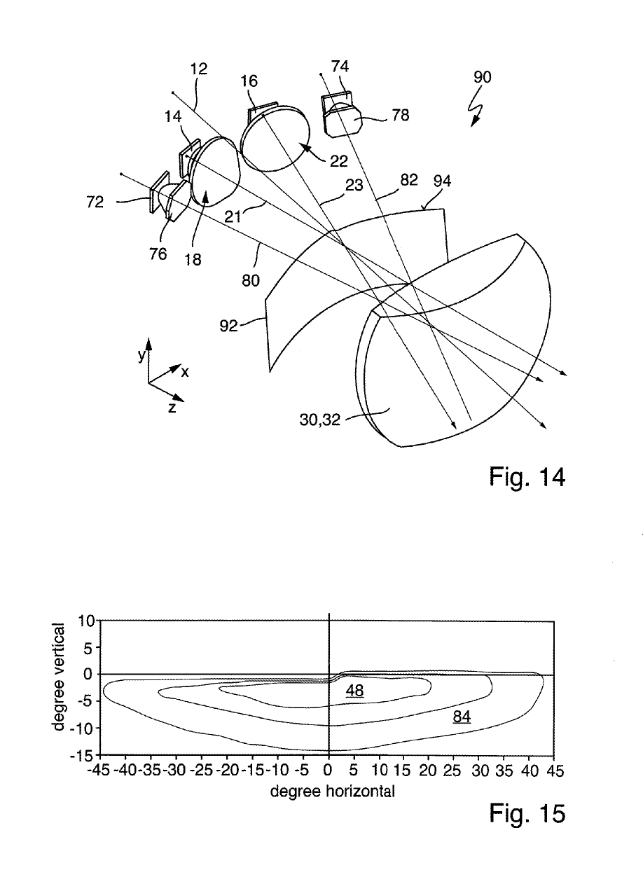

Another embodiment of the invention is shown in FIG. 14. The light module 90 shown there differs from the light module 70 shown in FIG. 9 in that it provides an aperture 92. In this way, it is possible to generate a radiated light distribution with a light-dark border (dimmed light distribution).

For this purpose, the plate-like aperture 92 is bordered by an aperture edge 94. The aperture edge 94 extends in sections on the intermediate image surface. The aperture edge 94 includes a first horizontal section and an adjoining second horizontal section which in comparison to the first section is offset in the form of a vertical step. At the same time, the first horizontal section is connected with the second horizontal section via an oblique edge portion.

The aperture 92 hides a portion of the light distribution projected by the intermediate image surface via the secondary optics device 30. Therefore, the light distribution emitted by the light module 90 also includes a corresponding hidden portion.

FIG. 15 shows the light distribution emitted by the light module 90 when all light sources (semiconductor light sources 14, 16, as well as sidelight sources 72 and 74) are operating. It can be seen that compared with the representation in FIG. 12, only those sections of the light beam distribution 48 and sidelight distribution 84 are illuminated which are not shaded by the aperture on the intermediate image surface. In this respect, the light distribution emitted by the light module 90 comprises a light-dark border which corresponds in its course to the aperture edge 94. The secondary convex lens 32 reproduces the aperture edge 94 as asymmetric light-dark border. It includes two boundary lines that extend horizontally and are offset vertically toward one another. The boundary lines are connected by a boundary line that ascends by an angle of particularly 15°. At the same time, the vertically lower section of said asymmetric light-dark border defines the oncoming traffic area of the light beam distribution in which intentional dazzling of oncoming traffic can be avoided.

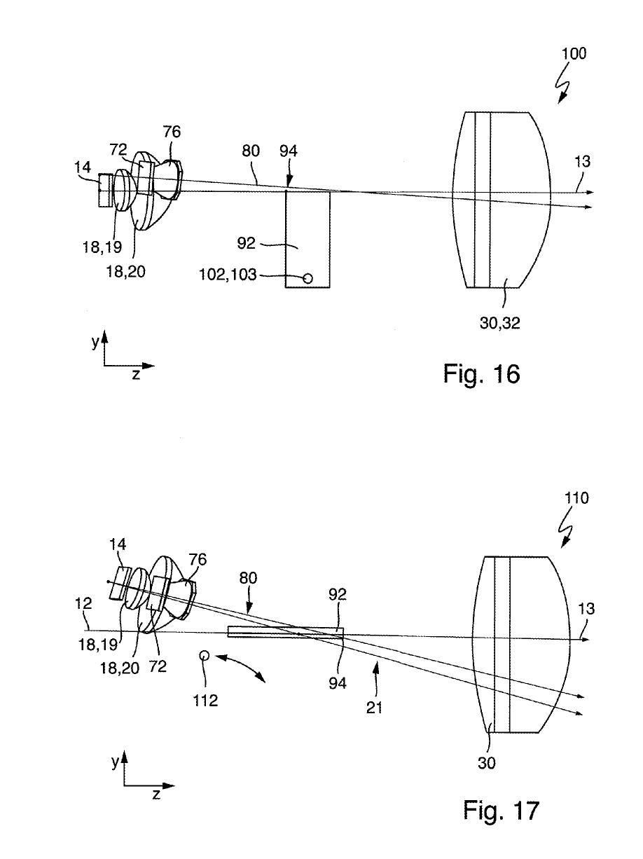

In one embodiment, the aperture 92 is arranged to be moveable, as described by means of the light module 100 represented in FIG. 16. The light module 100 is shown from a lateral view vertically to the primary beam direction 13 and basically corresponds to the light module 90. However, in contrast, the aperture 92 can be folded in and out of the optical path.

For this purpose, the aperture 92 is arranged on a rotational axis 102 of an aperture actuator 103 (for example, torque motor, not shown), and the rotational axis extends vertically to the primary beam direction 13 (in this case in X direction. The aperture 92 can be tipped by means of the aperture actuator 103 in such a way that the aperture edge 94 is tilted out of the intermediate image surface, starting from the position shown in FIG. 16. For example, this can occur when the aperture actuator 103 turns the rotational axis 102 clockwise (see FIG. 16), thus tilting the plate-like aperture 92 in the direction of the secondary optics device 30.

FIG. 17 shows another embodiment for activating and de-activating the aperture of a light module 110. In contrast to the light module 100, here the aperture 92 extends horizontally, not vertically. At the same time, the optical axis 12 of the light module 110 extends through the plate-like aperture 92. The aperture 92 is arranged in such a way that the aperture edge 94 extends in the area of the intermediate image surface.

In the light module 110, the first semiconductor light source 14 and the sidelight source 72 (also the second semiconductor light source 16 and the second sidelight source 74 that are not shown) are arranged in such a way that the optical axes (first optical axis 21 and first lateral optical axis 80) assigned to said light sources are tilted vertically by a non-vanishing angle in relation to the optical axis 12 of the light module 110 (which corresponds to the optical axis of the secondary optics device 30). Therefore, by means of the horizontally extending aperture 92, a part or portions of the light distribution are hidden on the intermediate image surface.

At the same time, it is possible that the surface of the plate-like aperture 92 irradiated by the light sources 14 and 72 is designed in the form of a mirror. As a result, the hidden light distribution is in addition directed to the illuminated area of the emitted light distribution.

The light module 110 is also provided with an aperture actuator that is operable to move the aperture 92 back and forth along the optical axis 12 into the X-Z plane. By means of arrows, it is indicated in FIG. 17 that it is also possible to tilt the aperture 92 by an aperture actuator about a rotational axis 112. As a result, the aperture edge 94 can be moved, respectively, in and out of the intermediate image surface.

All of the embodiments of the light modules of the present invention may also include an adjusting device which can be used to change in a controlled manner the position of the first semiconductor light source 14 in relation to the second semiconductor light source 16. However, it is also possible to provide an adjusting device by means of which it is possible to change the alignment or position of the primary optics devices 18 and 22 in relation to one another and/or in relation to the positions of the respectively assigned semiconductor light sources 14 or 16. As a result, it is possible to adjust the position of the intermediate images in relation to one another and thus the position of the light beam segments in relation to one another.

It should be appreciated by those having ordinary skill in the related art that the invention has been described above in an illustrative manner. It should also be appreciated that the terminology that has been used above is intended to be in the nature of words of description rather than of limitation and that many modifications and variations of the invention are possible in light of the above teachings. Thus, within the scope of the appended claims, the invention may be practiced other than as specifically described above.

What is claimed is:

1. A light module for a lighting device comprising:
at least one first and one second semiconductor light source, wherein each semiconductor light source comprises a plurality of LEDs, arranged in groups, for emitting one source light segment, respectively;
at least one first primary optics device assigned to at least one first semiconductor light source and at least one second primary optics device assigned to at least one second semiconductor light source; and
a secondary optics device for projecting the source light segments in a light beam distribution of the light module in such a way that the light beam distribution includes light beam segments which are overlapping one another and which are assigned to respective source light segments wherein the first and the second primary optics device have been designed as optical imaging devices to be used in such a way that each LED can be reproduced as a real intermediate image on an intermediate image surface, and wherein an intermediate image assigned to the first semiconductor light source is overlapping with at least one intermediate image assigned to the second semiconductor light source, and that the secondary optics device is arranged in such a way that the intermediate images of source light segment-emitting LEDs are projected as respectively assigned light beam segments of the light beam distribution.

2. The light module as set forth in claim 1 wherein the individual LEDs of the first and the second semiconductor light source can be controlled for emitting light independent of one another and/or can be switched on and off independent of one another.

3. The light module as set forth in claim 1 wherein at least some of the LEDs of the first and the second semiconductor light source are each regularly arranged in a linear array.

4. The light module as set forth in claim 1 wherein the LEDs of the first and the second semiconductor light source are each regularly arranged on a planar array.

5. The light module as set forth in claim 1 wherein the first and the second primary optics device produce the intermediate images assigned to the first semiconductor light source offset in horizontal direction (X) in relation to the intermediate images assigned to the second semiconductor light source.

6. The light module as set forth in claim 1 wherein the first and the second primary optics device produce intermediate images assigned to the first semiconductor light source offset in a vertical direction (Y) that extend perpendicular to the horizontal direction in relation to the intermediate images assigned to the second semiconductor light source.

7. The light module as set forth in claim 1 wherein each intermediate image produced by the first and second primary optics device is so indistinct on the intermediate image surface that a continuous transition from light to dark is achieved along at least one direction on the intermediate image surface.

8. The light module as set forth in claim 1 wherein the first and the second primary optics device, as well as the first and the second semiconductor light source are designed in such a way that the intermediate images assigned to a respective semiconductor light source directly adjoin one another on the intermediate image surface, and that an intermediate image assigned to the first semiconductor light source overlaps more than half of the width of at least one intermediate image assigned to the second semiconductor light source.

9. The light module as set forth in claim 1 wherein at least one of the first and the second primary optics device includes an optical element for correcting image defects.

10. The light module as set forth in claim 1 wherein the secondary optics device includes a secondary convex lens which defines a focal point, whereas the secondary convex lens is arranged in such a way that the focal point is located on the intermediate image surface.

11. The light module as set forth in claim 1 further including at least one sidelight source that produces light that can be radiated on the intermediate image surface in such a way that the secondary optics device can be used to project a sidelight distribution that is adjoining the light beam segments or that is surrounding said light beam segments in sections or completely.

12. The light module as set forth in claim 11 wherein the sidelight source includes a side-emitting optical device that produces light that is concentrated or collimated by the sidelight source on the intermediate image surface.

13. The light module as set forth in claim 1 further including an aperture having an aperture edge which can be arranged between the first and the second primary optics device and the secondary optics device in such a way that a light beam distribution can be achieved with a partially horizontally extending light-dark edge.

14. The light module as set forth in claim 13 further including an aperture actuator for moving the aperture in such a way that the aperture edge can be moved into the intermediate image surface and out of the intermediate image surface.

15. The light module as set forth in claim 1 further including an adjusting device that shifts the first semiconductor light source in a controlled manner in relation to the second semiconductor light source and/or in relation to the first primary optics device.
